(19) United States
(12) Patent Application Publication
(10) Pub. No.: US 2024/0347809 A1
(43) Pub. Date: Oct. 17, 2024

(54) THERMAL REGULATION DEVICE FOR COOLING ELECTRICAL ENERGY STORAGE MEANS

(71) Applicant: VALEO SYSTEMES THERMIQUES, La Verriere (FR)

(72) Inventors: Aurelie BELLENFANT, La Verriere (FR); Fethy DJALLAL, La Verriere (FR); Julien VERON, La Verriere (FR); Juan Carlos BATISTA, La Verriere (FR); Marc HERRY, La Verriere (FR)

(73) Assignee: VALEO SYSTEMES THERMIQUES, La Verriere (FR)

(21) Appl. No.: 18/292,083

(22) PCT Filed: Jul. 25, 2022
(86) PCT No.: PCT/EP2022/070850

§ 371 Date: Jan. 25, 2024

(30) Foreign Application Priority Data
Jul. 26, 2021 (FR) FR2108089

(51) Int. Cl. H01M 10/6557; H01M 10/613; H01M 10/625; H01M 50/213; H01M 50/249

(52) U.S. Cl. CPC H01M 10/6557; H01M 10/613; H01M 10/625; H01M 50/213; H01M 50/249

(57) ABSTRACT

A thermal regulation device for cooling electrical energy storage members, the thermal regulation device including a tube that is configured to be in contact with the electrical energy storage members and that includes at least one channel for circulating heat transfer fluid, a collecting tank that is disposed at one end of the tube and that includes collecting chambers that fluidically communicate with the at least one circulation channel of the tube, and at least two connecting sleeves disposed on either side of the collecting tank and configured to communicate with the same collecting chamber, the connecting sleeves having shapes that are distinct from one another.

### TECHNICAL FIELD

The field of the present invention is that of thermal regulation devices. The present invention relates more particularly to the implementation means for cooling the electrical energy storage members with which such vehicles are equipped.

### BACKGROUND OF THE INVENTION

Nowadays, it is known for electric, combustion-engine or hybrid vehicles to be equipped with electrical energy storage members allowing an electrical power supply for different elements of the vehicle. These electrical energy storage members are generally composed of electrical energy storage cells positioned in a battery pack.

Motor-vehicle manufacturers are nowadays seeking to supply more powerful electric or hybrid vehicles that have an increased range. To this end, more and more battery packs, and/or larger and larger battery packs, are installed on these electric or hybrid vehicles. It is known for the assembly or at least a portion of these battery packs to be installed in the floor of the vehicle, substantially over the entire width of the vehicle.

It is understood that, when the vehicle is running, the battery packs can release a large quantity of heat and consequently be subjected to temperature increases that can in certain cases damage or even destroy them. Therefore, their cooling is essential in order both to keep them in good condition and to ensure the reliability, range and performance level of the vehicle. Furthermore, the operation of the battery packs can be less efficient in the event of low temperatures, the electrical or electronic components equipping these battery packs then needing time to build up temperature before operating at full capacity.

To do this, one or more thermal regulation devices intended to regulate the temperature of the battery packs are implemented so as to ensure the heating and/or cooling functions of the electrical or electronic components inside these battery packs and to thus optimize the operation of the different components.

These thermal regulation devices are generally passed through by a heat transfer fluid which can, according to requirements, either absorb the heat emitted by each battery pack in order to cool it or supply heat if the temperature of the battery pack is insufficient for good operation thereof.

In battery packs in which electrical energy storage cells are disposed vertically one beside the other so as to form a plurality of successive rows of cells, it is notably known to have thermal regulation devices having a tube which is disposed between two rows of cells and within which the heat transfer fluid is able to circulate. The contact between the tube and the cells allows heat energy to be discharged, or supplied, via the heat transfer fluid. To manage the intake and discharge of the heat transfer fluid, a fluid collecting tank is disposed at one end of the tube and heat transfer fluid intake and outlet ducts are connected to this collecting tank. More particularly, when several thermal regulation devices are disposed in parallel so as to be respectively inserted between two rows of cells, and when the ducts have to be connected successively to each collecting tank of the thermal regulation devices, it is known for respectively the intake duct and the outlet duct for heat transfer fluid to be formed by a succession of tubular portions including sleeves that are secured to each collecting tank and additional connecting means that are interposed between the sleeves so as to fasten them to one another and allow a leak-tight passage of heat transfer fluid within each of the tubular portions.

The size of the battery packs has to be larger and larger in order to meet the increasingly great electrical energy needs of modern electric and hybrid vehicles, and the number of rows of cells, and therefore the number of tubes interposed between these rows of cells to carry out the thermal regulation, has to increasingly great. This has the result that the connection of the ducts to the different collecting tanks can be laborious due to the great number of parts to be assembled together.

Furthermore, the multiplication of the number of parts and of their respective manufacturing tolerances involves greater assembly clearances and increased complexity in carrying out this assembly.

### SUMMARY OF THE INVENTION

In this context, the present invention proposes an alternative to the existing devices, having as its subject a thermal regulation device for cooling electrical energy storage members, the thermal regulation device comprising a tube that is configured to be in contact with the electrical energy storage members and that comprises at least one channel for circulating heat transfer fluid, a collecting tank that is disposed at one end of the tube and that comprises collecting chambers that fluidically communicate with the at least one circulation channel of the tube, and at least two connecting sleeves disposed on either side of the collecting tank and configured to communicate with the same collecting chamber, the connecting sleeves having shapes that are distinct from one another.

According to the invention, the collecting tank is therefore equipped with at least two connecting sleeves including a connecting sleeve of a first type and a connecting sleeve of a second type. The difference in shape between the connecting sleeves makes it possible, when two identical thermal regulation devices are assembled with one another so as to form part of an electrical energy storage device notably with several rows of electrical energy storage members, to make a connecting sleeve of a first type associated with a first thermal regulation device cooperate directly with a sleeve of a second type associated with a second thermal regulation device.

Advantageously, the need to provide an assembly with connecting sleeves of identical shapes that must be connected by an additional sheath is thus avoided, and a multiplication of the manufacturing tolerances and of alignment errors is thus avoided.

According to one feature of the invention, the collecting tank and the two connecting sleeves form a one-piece assembly. Notably, the collecting tank and the connecting sleeves can be made of the same material, and more particularly made of aluminum. Additionally, the collecting tank, the connecting sleeves and the tube form a one-piece assembly.

According to one feature of the invention, the one-piece assembly formed by at least the collecting tank and the connecting sleeves is obtained by a brazing operation.

According to one feature of the invention, one of the two connecting sleeves, so as to form a male element, has an outer diameter, at a free end opposite the collecting tank, that is slightly smaller than the inner diameter of the other of the two connecting sleeves at a free end opposite the collecting tank, this other connecting sleeve being intended to form a female element.

According to one feature of the invention, one of the two connecting sleeves has a free end, in the direction away from the collecting tank, that has smaller outer dimensions than the corresponding outer dimensions of this connecting sleeve in the vicinity of the collecting tank, and/or the other of the two connecting sleeves has a free end, in the direction away from the collecting tank, that has greater inner dimensions than the corresponding inner dimensions of this connecting sleeve in the vicinity of the collecting tank.

In other words, the thermal regulation device comprises a connecting sleeve of a first type that exhibits a male shape, where appropriate that tends to taper as the distance from the collecting tank increases, and a connecting sleeve of a second type that exhibits a female shape, where appropriate that tends to widen as the distance from the collecting tank increases in a direction opposite to the direction in which the connecting sleeve of the first type extends away, the male shape and the female shape of these connecting sleeves enabling direct cooperation, notably by press fit, between two connecting sleeves of two adjacent thermal regulation devices.

According to one feature of the invention, a first connecting sleeve associated with the collecting tank comprises means for cooperating with a connecting sleeve of a first adjacent thermal regulation device that are disposed on its outer face, and a second connecting sleeve forming a one-piece assembly with the collecting tank, and disposed in the direction away from the first connecting sleeve with respect to said collecting tank, comprises means for cooperating with a connecting sleeve of a second adjacent thermal regulation device that are disposed on its inner face.

According to one feature of the invention, the cooperation means comprise at least one zone for receiving an annular sealing gasket protruding from the corresponding face of the first or second connecting sleeve.

According to one feature of the invention, the receiving zone comprises a groove formed in the thickness of the corresponding face of the first or second connecting sleeve and dimensioned to accommodate the at least one annular sealing gasket.

According to one feature of the invention, one of the connecting sleeves comprises at least one slot passing through the thickness of this sleeve from the inner face to the outer face, said slot being configured to receive a fastening clip.

According to one feature of the invention, the tube comprises two separate circulation channel assemblies, and the collecting tank comprises two collecting chambers that fluidically communicate respectively with one of the circulation channel assemblies of the tube, two pairs of connecting sleeves being disposed, with one connecting sleeve on either side of the collecting tank, so as to communicate with each of the collecting chambers, the pairs of connecting sleeves being configured such that a connecting sleeve of a first pair of connecting sleeves that is disposed on a first side of the collecting tank has a shape and dimensions identical to those of a connecting sleeve of the second pair of connecting sleeves that is disposed on the second side of the collecting tank.

The invention also relates to an electrical energy storage device for an electric or hybrid vehicle, comprising several assemblies of electrical energy storage members and several thermal regulation devices as mentioned above, each thermal regulation device being arranged between two assemblies of electrical energy storage members, two adjacent thermal regulation devices being configured to be connected in a leak-tight manner by direct cooperation of a connecting sleeve of a first thermal regulation device, equipped with a sealing gasket, with a connecting sleeve of a second thermal regulation device.

The invention also relates to a method for assembling an electrical energy storage device as claimed in the preceding claim, during which electrical energy storage members are placed against a tube of a first thermal regulation device, and then a tube of a second thermal regulation device is placed against the previously placed electrical energy storage members, by inserting the connecting sleeves that are associated with this tube of the second device and that are disposed on one side of the collecting tank of the second device directly into the connecting sleeves that are associated with the tube of the first device and that are disposed on one side of the collecting tank of the first device.

### BRIEF DESCRIPTION OF THE DRAWINGS

Further features, details and advantages of the invention will become more clearly apparent from reading the following description, and also from studying several exemplary embodiments given by way of non-limiting indication, with reference to the appended schematic drawings, in which:

FIG. 1 is a perspective representation of a battery pack as a whole equipped with several electrical energy storage members and with a plurality of thermal regulation devices according to the invention;

FIG. 2 is a detail view of several electrical energy storage members and of one end of several thermal regulation devices, seen in FIG. 1;

FIG. 3 is a perspective representation of a thermal regulation device according to a first embodiment in which the circulation of the heat transfer fluid intended to circulate in this device has been shown by solid arrows;

FIG. 4 is a perspective representation of a thermal regulation device according to a second embodiment in which the circulation of the heat transfer fluid intended to circulate in this device has been shown by solid arrows;

FIG. 5 is a perspective representation of one end of a thermal regulation device, rendering visible a distribution tank and connecting sleeves protruding on either side of this tank;

FIG. 6 is a view in section of two adjacent thermal regulation devices, notably rendering visible the cooperation between the connecting sleeves that are formed in one piece with the distribution tank formed at the end of the corresponding thermal regulation device;

FIG. 7 is a schematic representation, similar to that in FIG. 3, in which the distribution tank has been shown in part so as to render visible its internal structure and so as to render visible the internal structure of the tube, at one end of which the distribution tank is fastened;

FIG. 8 is a perspective view of the tube in FIG. 5;

FIG. 9 is a perspective representation, from a perspective angle similar to that in FIG. 3, illustrating a first variant embodiment of the invention;

FIG. 10 is a view in section of two adjacent thermal regulation devices, in a section plane similar to that in FIG. 4, illustrating the variant embodiment in FIG. 7;

FIG. 11 is a view in section of a tube according to a first alternative embodiment of the invention;

FIG. 12 is a view in section of a tube according to a second alternative embodiment of the invention;

FIG. 13 is a perspective representation, from a perspective angle similar to that in FIG. 9, illustrating a second variant embodiment of the invention; and

FIG. 14 shows a method according to the invention.

### DETAILED DESCRIPTION OF THE INVENTION

The features, variants and different embodiments of the invention can be combined with one another, in various combinations, as long as they are not mutually incompatible or mutually exclusive. It will be possible, in particular, to conceive of variants of the invention that comprise only a selection of the features described hereinafter, in isolation from the other features described, if this selection of features is sufficient to confer a technical advantage and/or to distinguish the invention from the prior art.

In the following description, the terms “longitudinal”, “transverse” and “vertical” refer to the orientation of a thermal regulation device according to the invention. A longitudinal direction corresponds to a main direction of extension of a thermal regulation device and a transverse direction corresponds to a direction that is substantially perpendicular to a main plane of extension of a thermal regulation device and to a main direction of extension of a hydraulic connecting sleeve of the thermal regulation device, this transverse direction being perpendicular to the longitudinal axis L. Lastly, a vertical direction is perpendicular to the longitudinal direction and to the transverse direction.

An electrical energy storage device 1 according to one aspect of the invention, notably intended to equip an electric or hybrid vehicle, comprises several assemblies of electrical energy storage members 2, also called electrical energy storage cells hereinafter, and several thermal regulation devices 4 arranged in the vicinity of the cells so as to enable a heat exchange between them.

The electrical energy storage members notably have the shape of cylindrical cells, in this case of circular section, that are disposed vertically, that is to say perpendicularly with respect to the longitudinal and transverse plane in which the electrical energy storage device is mainly inscribed.

The electrical energy storage members 2 are notably disposed in successive rows 3 that are parallel to one another, and each row, or assembly of electrical energy storage members, extends mainly longitudinally.

Thermal regulation devices 4 are disposed between two adjacent rows 3 of electrical energy storage members, notably with a tube 6 which is configured to be in contact with the electrical energy storage members 2 of these two adjacent rows 3.

In the illustrated example, the rows 3 are disposed in staggered fashion with respect one another, that is to say with a longitudinal offset of the storage members of one row with respect to the storage members of the adjacent row, thus making it possible to optimize the size of the electrical energy storage device 1, and the thermal regulation devices 4 each comprise a tube 6 of corrugated shape so as to be able to be in contact with each of the electrical energy storage members 2 of the two rows 3 between which they respectively extend.

Heat transfer fluid is intended to circulate inside this tube 6 of corrugated shape so as to be able to exchange heat energy with the electrical energy storage members 2, via the heat-conducting wall of the tube. Notably, when the electrical energy storage members 2 have to be cooled following a rise in temperature during their operation, the heat transfer fluid is intended to recover heat energy and discharge it out of the electrical energy storage device 1.

In order to allow this exchange of heat energy, each thermal regulation device 4 comprises the tube 6 mentioned above, in this case of corrugated shape, within which at least one channel 8 for circulating heat transfer fluid is formed, and at least one collecting tank 10 which is disposed at one longitudinal end 12 of the tube 6 and which is intended to collect the fluid from a heat transfer fluid intake duct 14 and to distribute it into the circulation channel or channels 8 within the tube 6 and/or which is intended to collect the heat transfer fluid at the outlet of the tube 6 and to direct it into a heat transfer fluid discharge duct 16.

In other words, the heat transfer fluid is intended to circulate in the intake duct, and at each collecting tank encountered by the intake duct, a portion of heat transfer fluid is directed toward this collecting tank and the associated thermal regulation device and another portion of heat transfer fluid is directed through the intake duct in order to supply the following collecting tank.

According to the invention, the heat transfer fluid intake duct 14 and the heat transfer fluid discharge duct 16 are formed by the direct cooperation of connecting sleeves 18 that are secured to two adjacent collecting tanks 10, without there being any intermediate devices arranged between these connecting sleeves 18, it being understood that, where appropriate, a sealing gasket can be borne by one of the connecting sleeves and bear against the other connecting sleeve in the direct connecting zone between the sleeves.

Those features relating to the connecting sleeves 18 which notably enable the direct cooperation as mentioned will be described in more detail below.

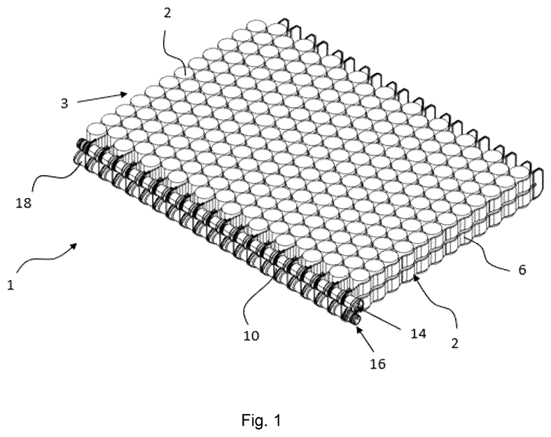

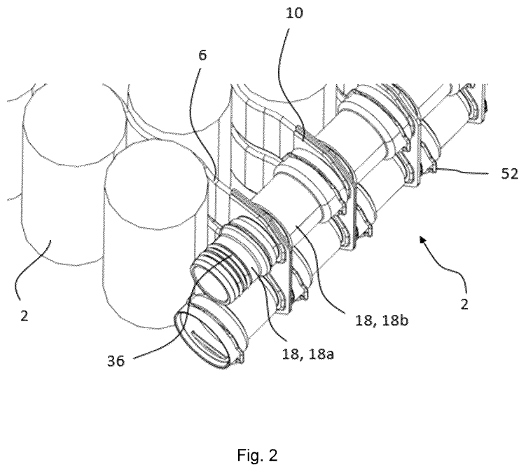

It can, however, be noted at this stage in the description, according to the illustrations in FIGS. 1 and 2, that two connecting sleeves 18 extend on either side of a collecting tank 10 so as to form a pair 19, and that the two connecting sleeves 18 of this pair have a different shape from one another, so as to allow the sleeve of a first type 18a associated with a first collecting tank 10 to be connected directly to a sleeve of the second type 18b associated with a second collecting tank 10, without it being necessary to provide additional connecting means.

Furthermore, it can be noted that each assembly formed by a collecting tank 10 and its connecting sleeves 18 is identical from one thermal regulation device 4 to the other.

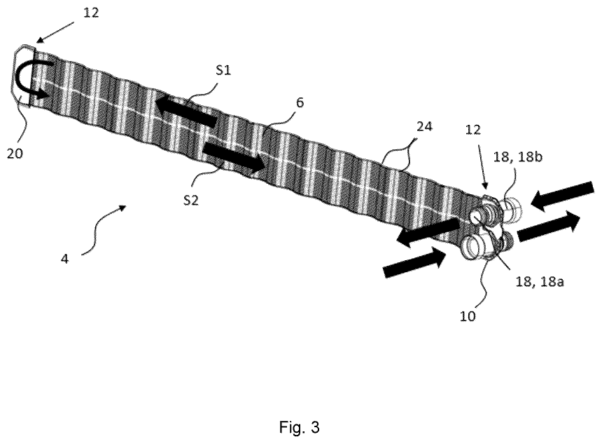

FIG. 3 illustrates a first embodiment of the thermal regulation device according to the invention, in which the circulation of the fluid is referred to as U-type circulation, that is to say with the same portion of heat transfer fluid circulating in both directions within the tube 6 after having passed through a return tank 20 at one of the longitudinal ends of the tube.

More particularly, in this first embodiment, the thermal regulation device 4 comprises a tube 6 and, at each of its longitudinal ends, a collecting tank 10 and a return tank 20.

The tube 6 comprises several channels 8 formed within it, divided into two circulation assemblies that are distinguished in that the same portion of heat transfer fluid circulates in the first circulation direction S1 within channels of a first circulation assembly 21 and in a second circulation direction S2, opposite to the first circulation direction S1, within channels of a second circulation assembly 22.

The collecting tank 10 disposed at a first longitudinal end 12 of the tube is equipped with connecting sleeves 18 so as to allow the intake and discharge of the heat transfer fluid. The collecting tank 10 is configured to guide the fluid circulating in the connecting sleeves 18 that contribute to forming the heat transfer fluid intake duct 14 to one portion of the channels, in this case the channels of the first circulation assembly 21, within the tube and to guide the fluid exiting the tube through the other portion of the channels, in this case the channels of the second circulation assembly 22, into the connecting sleeves 18 that contribute to forming the heat transfer fluid discharge duct 16.

The return tank 20 disposed at a second longitudinal end of the tube 6 does not comprise any connecting sleeves and is only fluidically connected to the tube 6. The return tank 20 is configured to guide the fluid circulating in one direction in one portion of the circulation channels to the other portion of the circulation channels such that it circulates in the other direction.

This configuration has the result, as illustrated by the arrows visible in FIG. 3, that heat transfer fluid enters through a first connecting sleeve 18 of a pair 19, a portion of this heat transfer fluid passes through the tube 6 in a first circulation direction S1 while the other portion of this heat transfer fluid continues on its route through the intake duct 14 in the direction of an adjacent thermal regulation device 4, heat transfer fluid circulates within the channels of the first circulation assembly 21 in a first circulation direction S1, during which the heat transfer fluid recovers heat energy from or transfers it to the surface of the cells in contact with the tube 6, at its channels of the first circulation assembly 21, said heat transfer fluid changes direction in the return tank and passes through the tube in a second circulation direction S2, with heat transfer fluid this time circulating within the channels of the second circulation assembly 22 in the second circulation direction S2, during which the heat transfer fluid once again recovers heat energy from or transfers it to the surface of the cells in contact with the tube, at its channels of the second circulation assembly 22, and fluid exits via the second connecting sleeve 18 of said pair 19, joining the fluid coming from the adjacent thermal regulation device.

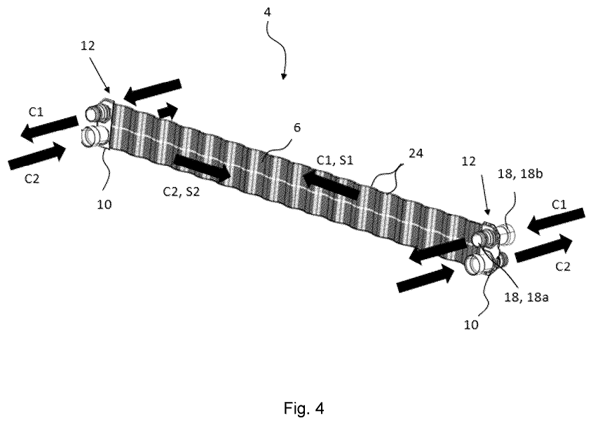

FIG. 4 illustrates a second embodiment of the thermal regulation device 4 according to the invention, in which the circulation of the heat transfer fluid is referred to as I-type circulation, that is to say with the same portion of heat transfer fluid circulating only in one direction within the tube 6.

More particularly, in this second embodiment, the thermal regulation device 4 comprises a tube 6 and, at each of its longitudinal ends, a collecting tank 10.

Again, the tube 6 comprises several channels 8 formed within it, divided into two circulation assemblies that are distinguished this time in that two different portions of fluid can circulate separately within the tube, in their respective assembly of channels. A first portion of heat transfer fluid can thus circulate in the first circulation direction S1 within the channels of the first circulation assembly 21 and a second portion of heat transfer fluid can circulate in a second circulation direction S2, opposite to the first circulation direction, within the channels of the second circulation assembly 22.

In this case, each collecting tank 10 is equipped with connecting sleeves 18 in accordance with the invention, that is to say configured so as to be able to cooperate directly with connecting sleeves of an adjacent collecting tank so as to form an intake duct 14 and a discharge duct 16 for heat transfer fluid. Again, each collecting tank 10 is configured to guide the heat transfer fluid circulating in the connecting sleeves 18 that contribute to forming the fluid intake duct 14 to one portion of the channels within the tube 6 and to guide the fluid exiting the tube through the other portion of the channels into the connecting sleeves 18 that contribute to forming the fluid discharge duct 16.

This configuration results in two separate circuits, as illustrated by the arrows visible in FIG. 4. A first circuit C1 comprises entry of fluid through a first sleeve of a first collecting tank, passage of one portion of this fluid through the tube in a first circulation direction while the other portion of this fluid continues on its route through the conveying duct in the direction of an adjacent thermal regulation device, and exit of the fluid via a first sleeve of the second collecting tank after having passed through the tube, so as to join the fluid coming from the adjacent thermal regulation device. And a second circuit C2 comprises entry of fluid through a second sleeve of a second collecting tank, passage of one portion of this fluid through the tube in a second circulation direction while the other portion of this fluid continues on its route through the conveying duct in the direction of an adjacent thermal regulation device, and exit of the fluid via a second sleeve of the first collecting tank after having passed through the tube, so as to join the fluid coming from the adjacent thermal regulation device.

In an alternative that is not shown here, an I-type circulation of the heat transfer fluid can be implemented with heat transfer fluid that circulates only in one direction within the tube 6, and with collecting tanks at each end of the tube that each comprise only two connecting sleeves. The heat transfer fluid circulates in the same direction in each of the channels within the tube, between a collecting tank forming a supply collecting tank at one end of the tube and another collecting tank forming a discharge collecting tank at the other end of the tube.

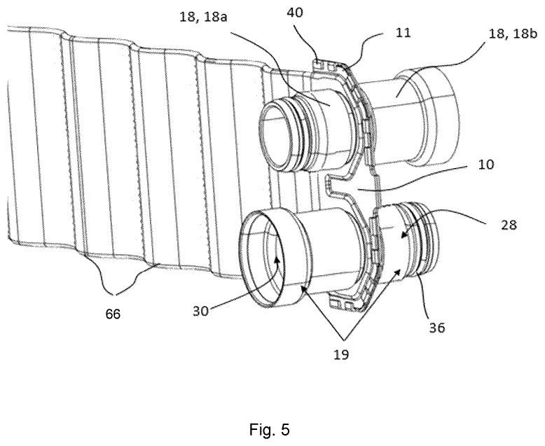

A thermal regulation device and a collecting tank equipped with connecting sleeves in accordance with the invention will now be described in greater detail, notably with reference to FIGS. 5 to 7. It should be noted that the following detailed description of the collecting tank can notably be applied to the two embodiments of the thermal regulation device that are mentioned above.

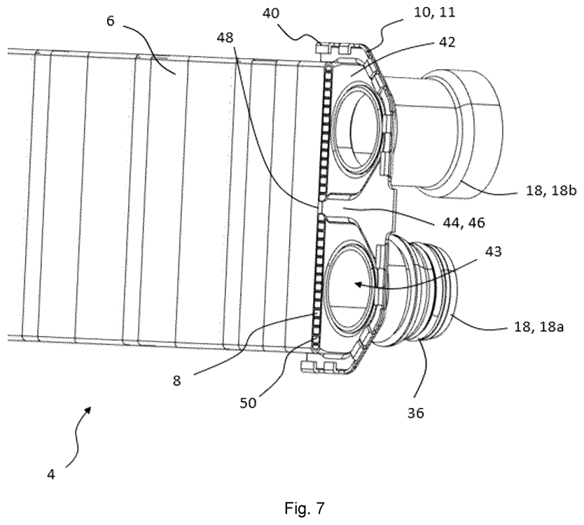

As mentioned, the thermal regulation device 4 comprises a tube 6 comprising at least one channel 8 for circulating heat transfer fluid, in this case a plurality of channels 8 as visible in FIG. 7, in which a shell that contributes to forming the collecting tank 10 has been removed in order to render visible the interior of said collecting tank and the presence of the channels in the tube.

The tube 6 has a plate shape extending in a longitudinal main direction of elongation, so as to follow the longitudinal direction of elongation of the row 3 of cells with which the tube must be in contact in order to perform the heat exchange function.

More particularly, in this case the tube 6 has a corrugated shape with a succession of crests 66 along the longitudinal direction of elongation of the tube, so as to be able to be in contact with each of the cells of the rows 3 surrounding tube 6, these rows being arranged in staggered fashion. It is understood that the channels 8 within the tube 6 follow the corrugated shape.

Furthermore, a collecting tank 10, disposed at one longitudinal end 12 of the tube 6, is more clearly visible in FIG. 5.

This collecting tank 10 is formed by two shells 11 that are applied against one another so as to define fluid collecting chambers 26 that communicate with the channels, as will be described below.

To convey or discharge the heat transfer fluid from these collecting chambers 26, connecting sleeves 18 are disposed on either side of the collecting tank 10, taking the form of hollow tubular portions guiding the circulation of fluid.

According to one feature of the invention, the collecting tank 10 and the two connecting sleeves 18 form a one-piece assembly, that is to say an assembly that cannot be disassembled without leading to the destruction of one and/or the other of the parts forming this assembly. This one-piece assembly can notably be obtained, prior to the assembly of the thermal regulation devices 4 in contact with the electrical energy storage members 2, by a brazing operation, it being notable that the brazing operation that renders the collecting tank 10 and the connecting sleeves 18 in one piece can be carried out simultaneously with a brazing operation that renders the tube integral with the collecting tank.

By way of non-limiting example of the invention, the collecting tank 10 and the connecting sleeves 18 are made of the same material, and more particularly made of aluminum.

As mentioned above, the connecting sleeves 18 are disposed on either side of the collecting tank 10 in pairs 19, a pair 19 of connecting sleeves being formed by two connecting sleeves whose axes of elongation, that is to say the axis of revolution of the tubular portion, are substantially coincident. The heat transfer fluid can flow from one connecting sleeve to the other connecting sleeve of the same pair, each pair 19 thus forming part of an intake duct 14 or discharge duct 16 for heat transfer fluid.

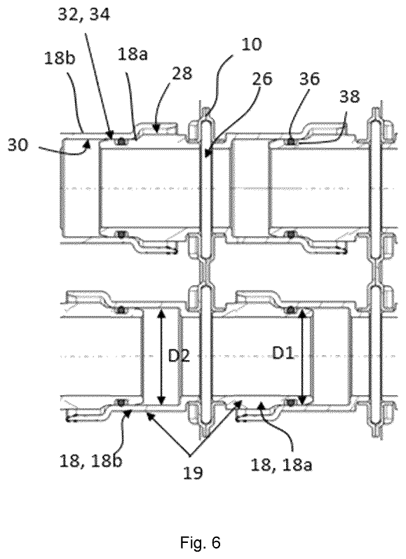

As mentioned, according to the invention, connecting sleeves 18 of two adjacent thermal regulation devices 4 cooperate directly so as to simplify the assembly process. FIG. 6 notably illustrates the fitting of a connecting sleeve of a thermal regulation device directly into a connecting sleeve of an adjacent thermal regulation device. In order to enable this direct cooperation, one connecting sleeve 18 of a pair 19 is configured as a male element and forms a sleeve of a first type 18a and the other connecting sleeve 18 of this pair 19 is configured as a female element and forms a sleeve of a second type 18b. The assembly of two adjacent thermal regulation devices with one another is realized by making a connecting sleeve of the first type 18a, or male sleeve, associated with one of the thermal regulation devices, cooperate with a connecting sleeve of the second type 18b, or female sleeve, associated with the other of the thermal regulation devices. In other words, the connecting sleeves of a same pair have shapes that are distinct from one another so as to enable direct cooperation without an intermediary between two connecting sleeves belonging to two adjacent thermal regulation devices, in a context in which the thermal regulation devices have identical shapes from one device to the other.

More particularly, a connecting sleeve of the first type 18a has an outer diameter, notably at a free end 180a opposite the collecting tank 10, the value D1 of which is slightly smaller than the value D2 of the inner diameter of a connecting sleeve of the second type 18b, notably at a free end 180b opposite the collecting tank.

It should be understood that the outer diameter of a connecting sleeve of the first type, that is to say a male element intended to be inserted into a female element, is considered to be slightly smaller than the inner diameter of a connecting sleeve of the second type since it allows the male element to be inserted by press fit into the female element.

As is notably illustrated in FIG. 5, considering a pair 19 of connecting sleeves, the connecting sleeve of the first type 18a has a free end, in the direction away from the collecting tank 10, that can have smaller outer dimensions than the corresponding outer dimensions of this connecting sleeve in the vicinity of the collecting tank, so as to have a male shape that tends to taper as the distance from the collecting tank increases, whereas the connecting sleeve of the second type 18b has a free end, in the direction away from the collecting tank 10, that can have greater inner dimensions than the corresponding inner dimensions of this connecting sleeve in the vicinity of the collecting tank, so as to have a female shape that tends to widen as the distance from the collecting tank increases.

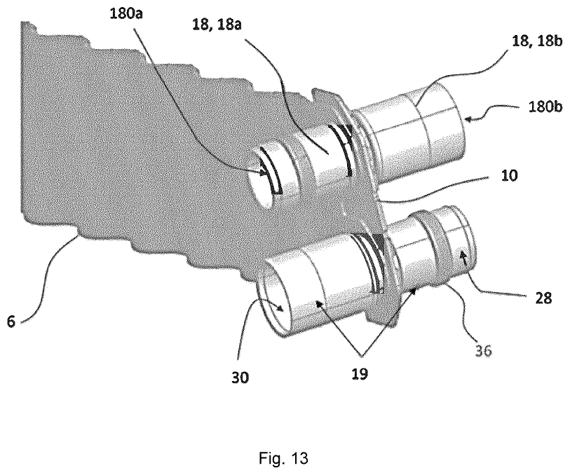

In a variant that is illustrated in FIG. 13, the connecting sleeves 18a, 18b form a tubular portion with substantially constant dimensions from the collecting tank to their free end 180a, 180b, with one of the connecting sleeves, forming the male sleeve, having an outer face 28 whose diameter is slightly smaller than the diameter of the inner face 30 of the other connecting sleeve, forming the female sleeve.

Regardless of the variant embodiment, a first male connecting sleeve associated with the collecting tank comprises means for cooperating with a female connecting sleeve of a first adjacent thermal regulation device that are disposed on its outer face 28, and a second female connecting sleeve, disposed in the direction away from the first male connecting sleeve with respect to said collecting tank, comprises means for cooperating with a male connecting sleeve of a second adjacent thermal regulation device that are disposed on its inner face 30.

The shape of each of these sleeves contributes to forming the means 32 for cooperation between the connecting sleeves, with a zone of the inner face 30 of a female connecting sleeve 18b that is dimensioned and designed to be in contact with a zone of the outer face 28 of a male connecting sleeve 18a.

Furthermore, a zone 34 for receiving an annular sealing gasket 36 is provided at the inner 30 and outer 28 faces of the connecting sleeves, said faces being intended to be in contact with a corresponding surface of another sleeve and forming these cooperation means 32. This annular sealing gasket 36 protrudes from the corresponding face of the connecting sleeve of the first or second type 18a, 18b. In the illustrated example, the annular sealing gasket 36 protrudes from the outer face 28 of the male connecting sleeve, but it will be understood that it could be associated with a female connecting sleeve and protrude from the inner face 30 of the latter.

As is notably visible in FIG. 6, the zone 34 for receiving the annular sealing gasket 36 can comprise a groove 38 formed in the thickness of the corresponding face of the connecting sleeve and dimensioned to accommodate the at least one annular sealing gasket 36.

As mentioned, two connecting sleeves form a pair 19 by being aligned and disposed on either side of the collecting tank 10. In the illustrated embodiment, the thermal regulation device 4 is such that two pairs 19 of connecting sleeves are secured to the collecting tank 10, once again forming a one-piece assembly, with, for each pair, one connecting sleeve disposed on either side of the collecting tank. In this way, each pair 19 of connecting sleeves can communicate with one of the collecting chambers 26.

In this context of a collecting chamber with two pairs of connecting sleeves, and as notably illustrated in FIG. 5, a connecting sleeve of a first pair of connecting sleeves that is disposed on a first side of the collecting tank 10 has a shape and dimensions identical to those of a connecting sleeve of the second pair of connecting sleeves that is disposed on the second side of the collecting tank 10.

In this way, and as is visible in FIG. 6, the direct cooperation of the connecting sleeves in the illustrated example with two pairs of connecting sleeves contributes to creating two parallel ducts, namely the heat transfer fluid intake duct 14 and the heat transfer fluid discharge duct 16.

FIG. 7 renders particularly visible the fact that the collecting tank 10 of the thermal regulation device 4 comprises within it collecting chambers 26 that fluidically communicate respectively with at least one of the circulation channels 8 formed within the tube, and more particularly one of the circulation assemblies 21, 22 formed by several channels.

The collecting tank 10 is in this case formed by two shells 11 that are applied and fastened against one another, with fastening means at the periphery of the shells. At least one shell comprises attachment tabs 40 that allow the shells to be held together prior to a brazing operation that sets the position of the shells and the integrity of the collecting tank.

Each shell 11 has two cavities 42 formed by deformation of the shell and a rib 44 disposed between the two cavities. It is understood that when the shells are fastened to one another, the cavities 42 of each shell 11 are disposed facing one another so as to form the collecting chambers 26 mentioned above, and the ribs 44 of each shell 11 are in contact with one another so as to form a central wall 46 which delimits and separates the collecting chambers 26 from one another.

This central wall 46 is intended to be in contact with a solid surface of the tube forming a sealing zone 48, which does not have any circulation channels, in order to ensure leak-tight contact and to prevent, within the collecting tank, fluid present in a first collecting chamber from pouring into the other collecting chamber, or into channels that must not be connected to this first collecting chamber.

Each cavity 42 is defined by a bottom wall 41 which is pierced by an orifice 43 substantially at its center. This orifice allows fluid to pass between the collecting chamber 26 formed by the cavity and a connecting sleeve 18 of the pair of connecting sleeves that opens out into this collecting chamber 26.

Each shell 11 is equipped with two connecting sleeves 18a, 18b which open out respectively into one of the two cavities 42 formed in this shell 11.

In other words, the connecting sleeves are configured to each communicate with a collecting chamber, and it is understood that the sleeves disposed on either side of the collecting tank are configured to communicate with the same collecting chamber.

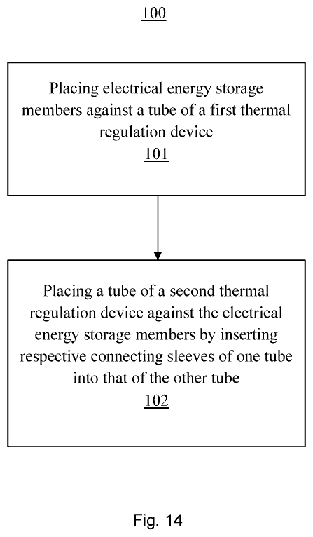

In relation to FIG. 14, a method 100 for assembling an electrical energy storage device 1 as was described earlier will now be described.

The thermal regulation devices are prepared beforehand by brazing of a collecting tank, connecting sleeves and a tube, so as to form a one-piece assembly. A sealing gasket is then applied, after this brazing operation, to one of the connecting sleeves of a pair of connecting sleeves that are secured to a collecting tank.

The method 100 is distinctive according to the invention in that it comprises at least a first step 101 during which electrical energy storage members 2 are placed against a tube 6 of a first thermal regulation device 4. During this step, it is notably possible to carry out a step of placing adhesive against that face of the tube which is intended to be in contact with the electrical energy storage members.

In a second step 102, a tube 6 of a second thermal regulation device is placed against the previously placed electrical energy storage members 2. The pressure exerted against the electrical energy storage members contributes to pressing the latter against the first tube and ensures the adhesive bonding between this first tube and the electrical energy storage members.

At the same time, the connecting sleeves 18 associated with this tube 6 of the second thermal regulation device 4 and disposed on one side of the collecting tank 10 of the second device are inserted directly into the connecting sleeves 18 associated with the tube of the first device and disposed on a side of the collecting tank of the first device facing the second device.

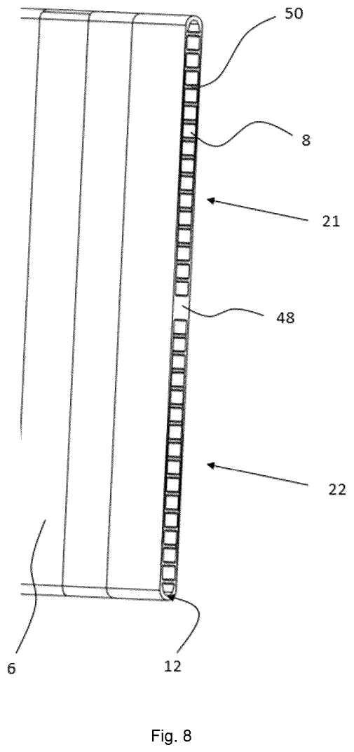

FIG. 8 renders particularly visible a tube 6 of a thermal regulation device 4 for cooling electrical energy storage members, the tube extending in a longitudinal main direction of elongation according to the orientation mentioned above.

The tube 6 is configured in such a way as to comprise a plurality of longitudinal channels 8 for circulating heat transfer fluid that are formed one beside the other in the material inside the tube. In the example illustrated in FIG. 8, these channels have a rectangular passage section, without this placing any limitation on the invention. The channels are through-channels, such that they open out onto each longitudinal end face 12 of the tube 6. As mentioned above, the longitudinal circulation channels 8 are divided into a first assembly 21 for circulating heat transfer fluid and a second assembly 22 for circulating heat transfer fluid, which notably allow heat transfer fluid to be circulated in two opposite directions within the tube 6.

As has been mentioned above, on at least one longitudinal end face 12 of the tube 6, a sealing zone 48 is disposed between the channels that contribute to forming the first circulation assembly 21 and the channels that contribute to forming the second circulation assembly 22.

The sealing zone 48 is a solid zone formed in a longitudinal end face 12 of the tube 6. The sealing zone can notably be disposed in the center of the longitudinal end face 12 of the tube along the transverse dimension.

This solid zone can either be formed by the material of the tube, no orifice being carved out of the material in this zone, or be obtained by way of a shut-off device, that is to say a local input of material, covering an orifice opening out onto this longitudinal end face.

In the first case, the sealing zone 48 extends over the entire longitudinal dimension of the tube 6, from one longitudinal end face 12 to the other, and in this regard a longitudinal strip of material, extending from one end face to the other, is not pierced by a circulation channel.

In the second case, the sealing zone 48 extends only over the longitudinal end face or faces 12 of the tube. Channels 8 extend at regular intervals over the entire transverse dimension of the tube, and a plug covers a channel on an end face, or a plate covers the end of several adjacent channels.

In greater detail, each circulation assembly 21, 22 has a transverse alignment of several longitudinal circulation channels 8 that are disposed in parallel with respect to one another. The transverse alignment of the channels of the first circulation assembly can notably be coincident with the transverse alignment of the channels of the second circulation assembly. The sealing zone 48 is disposed on the transverse alignment of each of the circulation assemblies.

The sealing zone 48 and the walls 50 delimiting adjacent channels 8 of the same circulation assembly should be distinguished. The sealing zone must notably be large enough to serve as a bearing surface in relation to the central wall 46 of the corresponding collecting tank 10.

More particularly, the sealing zone 48 extends between the two circulation assemblies 21, 22 over a transverse dimension at least equal to the corresponding transverse dimension of a longitudinal channel of one of the two circulation assemblies.

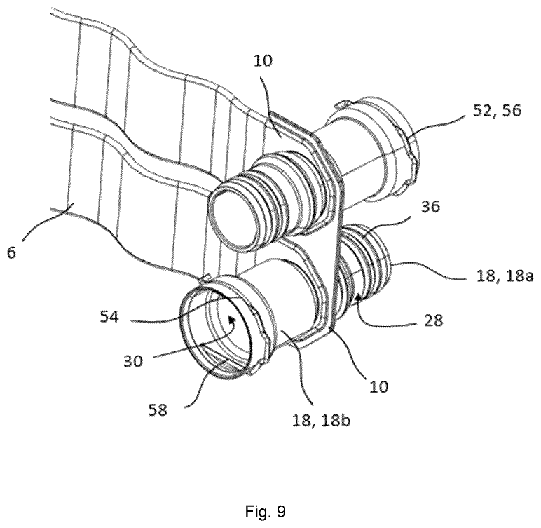

A variant embodiment of the invention is illustrated in FIG. 9, which differs from what has been described above in that it is additionally provided with fastening means 52 so as to ensure the position of the connecting sleeves that are brought into direct cooperation with one another.

In this variant, one of the connecting sleeves 18 of a pair of connecting sleeves of the thermal regulation device comprises a slot 54 passing through the thickness of this sleeve from the inner face 30 to the outer face 28, and the fastening means comprise, in addition to this slot, a fastening clip 56 able to be inserted in the slot once this sleeve is in direct cooperation with the connecting sleeve of an adjacent thermal regulation device.

The fastening clip 56 is dimensioned such that a branch 58 passing through the slot 54 faces an abutment surface formed in the connecting sleeve of the adjacent thermal regulation device. In order to ensure the retaining function of the fastening means, the branch 58 of the clip can be accommodated in a groove formed in the outer face of the connecting sleeve of the adjacent thermal regulation device.

In the illustrated example, two diametrically opposed slots are formed on a sleeve and the fastening clip comprises two branches dimensioned to be accommodated respectively in each of these slots.

Another difference consists in that the thermal regulation device comprises two separate tubes which are connected by the same collecting tank, instead of a single tube as described above. Such an embodiment can notably ensure that the heat transfer fluid circulates separately in each circulation channel, simplifying the problem of sealing between the collecting chambers within the collecting tank and the circulation channels.

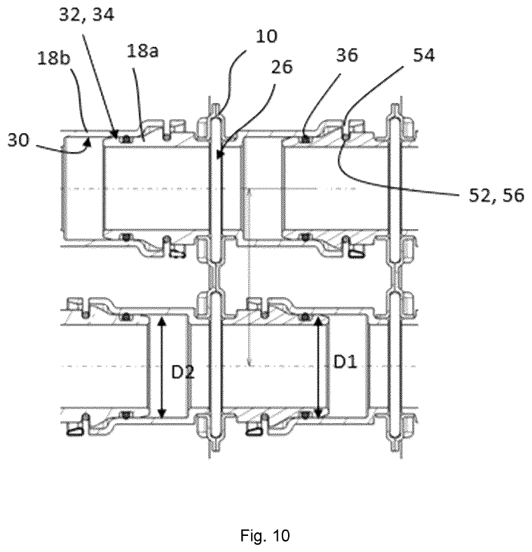

In accordance with the invention, this variant embodiment enables direct cooperation between the connecting sleeves, as illustrated in FIG. 10, without any intermediate part between the connecting sleeves other than the sealing gasket.

FIG. 10 renders visible, for this variant embodiment, the positioning of the fastening clip 56 passed through the slot 54 in order for said clip to be accommodated in a notch.

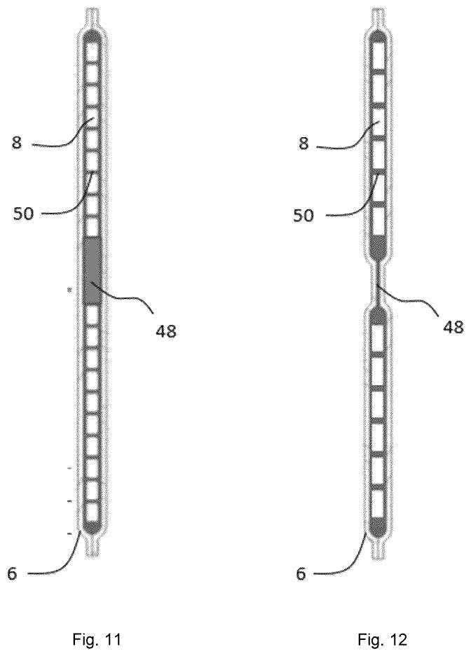

FIGS. 11 and 12 illustrate alternative embodiments of the tube, as has been described above with reference to FIG. 8.

In a first alternative, illustrated in FIG. 11, the tube 6 differs from what has been described above in that the transverse dimension of the sealing zone 48 is larger. More particularly, the transverse dimension of the sealing zone can be equal to at least two times the vertical dimension of a channel 8 for circulating heat transfer fluid. The vertical dimension is a compromise between a surface that is large enough to ensure sealing and a surface that does not have a significant impact on the quantity of heat transfer fluid that can circulate in a circulation assembly within the tube.

In a second alternative, illustrated in FIG. 12, the tube 6 differs from what has been described above in that the thickness of the sealing zone 48, that is to say a transverse dimension perpendicular to the vertical and longitudinal dimensions of the tube, is reduced with respect to the transverse dimension of the tube. This makes it possible to reduce the weight of the tube by removing material from a zone where it is not beneficial in terms of heat exchange to have contact with the electrical energy storage members since no heat transfer fluid circulates through this sealing zone.

The invention as has just been described is able to meet its stated objectives, namely of proposing an electrical energy storage device, in which thermal regulation devices, disposed respectively between two rows of cells of the storage device, can be easily connected to form a leak-tight assembly for circulating heat transfer fluid. This is possible by virtue of the production of a thermal regulation device comprising connecting sleeves configured to enable direct cooperation between connecting sleeves of adjacent thermal regulation devices.

The size of the electrical energy storage device can thus be easily increased without involving multiplication of the assembly operations.

The invention is not, however, limited to the means and configurations described and illustrated here, but also extends to any equivalent means or configuration and to any technically operational combination of such means. By way of non-limiting example, and as was mentioned earlier, the shapes of the sleeves can vary since the sleeves for connecting one thermal regulation device to the other can cooperate directly with one another.

What is claimed is:

1. A thermal regulation device for cooling electrical energy storage members, comprising a tube that is configured to be in contact with the electrical energy storage members and that includes at least one circulation channel for circulating a heat transfer fluid, a collecting tank that is disposed at one end of the tube and that includes collecting chambers that fluidically communicate with the at least one circulation channel of the tube, and at least two connecting sleeves disposed on either side of the collecting tank and configured to communicate with the same collecting chamber, the at least two connecting sleeves having shapes that are distinct from one another.

2. The thermal regulation device as claimed in claim 1, wherein the collecting tank and the at least two connecting sleeves form a one-piece assembly.

3. The thermal regulation device as claimed in claim 1, wherein one of the at least two connecting sleeves, so as to form a male element, has an outer diameter, at a free end opposite the collecting tank, that is slightly smaller than the inner diameter of the other of the at least two connecting sleeves at a free end opposite the collecting tank, this other connecting sleeve being intended to form a female element.

4. The thermal regulation device as claimed in claim 1, wherein one of the at least two connecting sleeves has a free end, in the direction away from the collecting tank, that has smaller outer dimensions than the corresponding outer dimensions of this one of the connecting sleeves in the vicinity of the collecting tank, and wherein the other of the at least two connecting sleeves has a free end, in the direction away from the collecting tank, that has greater inner dimensions than the corresponding inner dimensions of this connecting sleeve in the vicinity of the collecting tank.

5. The thermal regulation device as claimed in claim 1, wherein a first connecting sleeve of the at least two connecting sleeves, associated with the collecting tank, includes a first element for cooperating with a connecting sleeve of a first adjacent thermal regulation device that are disposed on its outer face, and wherein a second connecting sleeve of the at least two connecting sleeves, forming a one-piece assembly with the collecting tank, and disposed in the direction away from the first connecting sleeve of the at least two connecting sleeves with respect to said collecting tank, includes a second element for cooperating with a connecting sleeve of a second adjacent thermal regulation device that are disposed on its inner face.

6. The thermal regulation device as claimed in claim 5, wherein the cooperation means first and the second elements include at least one receiving zone for receiving at least one annular sealing gasket protruding from the corresponding face of the first or second connecting sleeve.

7. The thermal regulation device as claimed in claim 6, wherein the at least one receiving zone includes a groove formed in the thickness of the corresponding face of the first or second connecting sleeve and dimensioned to accommodate the at least one annular sealing gasket.

8. The thermal regulation device as claimed in claim 1, wherein one of the at least two connecting sleeves includes at least one slot passing through the thickness of this sleeve from the inner face to the outer face, said at least one slot being configured to receive a fastening clip.

9. The thermal regulation device as claimed in claim 1, wherein the at least one circulation channel includes two separate circulation channel assemblies, and wherein the collecting tank includes two collecting chambers that fluidically communicate respectively with one of the circulation channel assemblies, two pairs of connecting sleeves being disposed, with one connecting sleeve on either side of the collecting tank, so as to communicate with each of the collecting chambers, the pairs of connecting sleeves being configured such that a connecting sleeve of a first pair of connecting sleeves that is disposed on a first side of the collecting tank has a shape and dimensions identical to those of a connecting sleeve of the second pair of connecting sleeves that is disposed on the second side of the collecting tank.

10. An electrical energy storage device for an electric or hybrid vehicle, comprising several assemblies of electrical energy storage members and several thermal regulation devices, wherein each thermal regulation device includes a tube that is configured to be in contact with the electrical energy storage members and that includes at least one circulation channel for circulating a heat transfer fluid, a collecting tank that is disposed at one end of the tube and that includes collecting chambers that fluidically communicate with the at least one circulation channel of the tube, and at least two connecting sleeves disposed on either side of the collecting tank and configured to communicate with the same collecting chamber, the at least two connecting sleeves having shapes that are distinct from one another, with each thermal regulation device being arranged between two assemblies of electrical energy storage members, two adjacent thermal regulation devices being configured to be connected in a leak-tight manner by direct cooperation of a connecting sleeve of a first type, respectively of a second type, of a first thermal regulation device, equipped with a sealing gasket, with a connecting sleeve of a second type, respectively of a first type, of a second thermal regulation device.

11. A method for assembling an electrical energy storage device for an electric or hybrid vehicle, including several assemblies of electrical energy storage members and several thermal regulation devices, wherein each thermal regulation device includes a tube that is configured to be in contact with the electrical energy storage members and that includes at least one circulation channel for circulating a heat transfer fluid, a collecting tank that is disposed at one end of the tube and that includes collecting chambers that fluidically communicate with the at least one circulation channel of the tube, and at least two connecting sleeves disposed on either side of the collecting tank and configured to communicate with the same collecting chamber, the at least two connecting sleeves having shapes that are distinct from one another, with each thermal regulation device being arranged between two assemblies of electrical energy storage members, two adjacent thermal regulation devices being configured to be connected in a leak-tight manner by direct cooperation of a connecting sleeve of a first type, respectively of a second type, of a first thermal regulation device, equipped with a sealing gasket, with a connecting sleeve of a second type, respectively of a first type, of a second thermal regulation device, the method comprising:
placing electrical energy storage members are placed against a tube of a first thermal regulation device,
placing a tube of a second thermal regulation device against the previously placed electrical energy storage members, by inserting the connecting sleeves that are associated with this tube of the second device and that are disposed on one side of the collecting tank of the second device directly into the connecting sleeves that are associated with the tube of the first device and that are disposed on one side of the collecting tank of the first device.

12. The thermal regulation device as claimed in claim 1, wherein one of the two connecting sleeves has a free end, in the direction away from the collecting tank, that has smaller outer dimensions than the corresponding outer dimensions of this connecting sleeve in the vicinity of the collecting tank, or wherein the other of the two connecting sleeves has a free end, in the direction away from the collecting tank, that has greater inner dimensions than the corresponding inner dimensions of this connecting sleeve in the vicinity of the collecting tank.
